(19) United States
(12) Patent Application Publication
(10) Pub. No.: US 2026/0081177 A1
(43) Pub. Date: Mar. 19, 2026

(54) BATTERY CELL AND ELECTRIC DEVICE

(71) Applicant: Ningde Amperex Technology Limited, Ningde (CN)

(72) Inventor: Guowen ZHANG, Ningde (CN)

(73) Assignee: Ningde Amperex Technology Limited, Ningde (CN)

(21) Appl. No.: 19/326,751

(22) Filed: Sep. 12, 2025

(30) Foreign Application Priority Data
Sep. 13, 2024 (CN) 202411288388.X

(51) Int. Cl. H01M 4/66; H01M 4/02; H01M 4/38; H01M 50/119; H01M 50/186

(52) U.S. Cl. CPC H01M 4/667; H01M 4/386; H01M 4/669; H01M 50/119; H01M 50/186; H01M 2004/021; H01M 2004/027

(57) ABSTRACT

An electrode assembly includes a first electrode plate group and a second electrode plate group stacked along a first direction. Along a second direction, a length of the first electrode plate group is greater than a length of the second electrode plate group, the second direction is perpendicular to the first direction. The first electrode plate group includes a first electrode plate closest to the second electrode plate group, where the first electrode plate includes a current collector. The current collector includes a first region and a second region, both sides of the first region are provided with an active material layer, the second region is provided with the active material layer only on a side facing away from the second electrode plate group. The first region at least partially overlaps with the first electrode plate group.

### CROSS-REFERENCE TO RELATED APPLICATION

This application claims priority to the Chinese Patent Application Ser. No. 202411288388.X, filed on Sep. 13, 2024, the content of which is incorporated herein by reference in its entirety.

### TECHNICAL FIELD

The present application relates to the field of battery technology, and more particularly, to a battery cell and an electric device.

### BACKGROUND

With the rapid development of new energy technologies, battery cells have been widely applied in fields such as electronic devices, electric vehicles, electric two-wheelers, and electric tools. As the application of battery cells becomes increasingly widespread, higher requirements have been imposed on the energy density of battery cells.

### SUMMARY

Embodiments of the present application provide a battery cell and an electric device to increase the energy density of the battery cell.

According to a first aspect, an embodiment of the present application provides a battery cell, where the battery cell includes a packaging member and an electrode assembly. The electrode assembly is accommodated within the packaging member, and the electrode assembly is a laminated structure. The electrode assembly includes a first electrode plate group and a second electrode plate group, where the first electrode plate group and the second electrode plate group are stacked along a first direction. Along a second direction, a length of the first electrode plate group is greater than a length of the second electrode plate group, and the second direction is perpendicular to the first direction. The first electrode plate group includes a first electrode plate closest to the second electrode plate group, where the first electrode plate includes a current collector and an active material layer. The current collector includes a first region and a second region. Along a thickness direction of the current collector, both sides of the first region are provided with the active material layer, while the second region is provided with the active material layer only on a side facing away from the second electrode plate group. The first region at least partially overlaps with the first electrode plate group, and the second region at least partially does not overlap with the first electrode plate group.

In one or more optional embodiments, a dimension of the first electrode plate group in the second direction is greater than a dimension of the second electrode plate group in the second direction. The first electrode plate group includes the first electrode plate closest to the second electrode plate group, where the current collector of the first electrode plate includes the first region at least partially overlapping with the second electrode plate group and the second region at least partially not overlapping with the second electrode plate group. Both sides of the first region are provided with the active material layer, and the active material layer on the side of the first region facing the second electrode plate group can serve as an outermost electrode plate of the second electrode plate group, which is equivalent to a scheme where an outermost electrode plate of the second electrode plate group and an outermost electrode plate of the first electrode plate group share one current collector. Compared with a scheme where a current collector of an outermost electrode plate coated with the active material layer on a single surface of the first electrode plate group and a current collector of an outermost electrode plate coated with the active material layer on a single surface of the second electrode plate group are bonded via an adhesive layer, this scheme reduces the space occupied by the adhesive layer, thereby reducing the energy density loss of the battery cell in the first direction. Compared with the scheme where a current collector of an outermost electrode plate coated with the active material layer on a single surface of the first electrode plate group and a current collector of an outermost electrode plate coated with the active material layer on a single surface of the second electrode plate group are bonded via an adhesive layer, this scheme, by providing the first electrode plate, reduces the number of electrode plates coated with the active material layer on a single surface in the battery cell, thereby reducing the number of current collectors in the battery cell and further reducing the energy density loss of the battery cell in the first direction. Additionally, to mitigate the problems of warping and curling of the electrode plates coated with the active material layer on a single surface, the current collector of the electrode plate with single-surface coating is thick, which also leads to energy density loss of the battery cell. In this scheme, both sides of the first region of the current collector of the first electrode plate in the battery cell are provided with the active material layer, and the active material layers on both sides of the first region of the current collector of the first electrode plate can counteract stress, reducing the risk of warping and curling of the first electrode plate. This also allows the thickness of the first region of the current collector of the first electrode plate to be smaller compared to the thickness of the current collector of an electrode plate coated with the active material layer on a single surface, further reducing the energy density loss of the battery cell in the first direction. Furthermore, the second region of the current collector of the first electrode plate is provided with the active material layer only on the side facing away from the second electrode plate group, reducing the use of active material that does not contribute to capacity and avoiding the space occupied by such active material, further reducing the energy density loss of the battery cell in the first direction. Therefore, compared with the scheme where an electrode plate coated with the active material layer on a single surface of the first electrode plate group closest to the second electrode plate group and an electrode plate coated with the active material layer on a single surface of the second electrode plate group closest to the first electrode plate group are bonded via an adhesive layer, the battery cell of this scheme has a higher energy density.

In some embodiments of the first aspect of the present application, the packaging member forms an accommodation cavity, where the accommodation cavity includes a first accommodation cavity and a second accommodation cavity. The first accommodation cavity and the second accommodation cavity are arranged along the first direction, and along the second direction, a length of the second accommodation cavity is greater than a length of the first accommodation cavity. The active material layer includes a first active material layer provided on a side of the current collector facing the second electrode plate group and a second active material layer provided on a side of the current collector facing away from the second electrode plate group. At least a portion of the first active material layer and the second electrode plate group are accommodated in the first accommodation cavity, while the current collector and the second active material layer are accommodated in the second accommodation cavity.

In one or more optional embodiments, at least a portion of the first active material layer and the second electrode plate group are accommodated in the first accommodation cavity, while the current collector and the second active material layer are accommodated in the second accommodation cavity, fully utilizing the space within the packaging member in the first direction and reducing the gap between the first electrode plate group and the second electrode plate group and the inner wall of the packaging member in the first direction, which is beneficial to increasing the energy density of the battery cell.

In some embodiments of the first aspect of the present application, the current collector is a first metal layer.

In one or more optional embodiments, the current collector of the first electrode plate is a metal layer to ensure good electrical conductivity of the current collector.

In some embodiments of the first aspect of the present application, the current collector includes an insulating separation layer, a first metal layer, and a second metal layer. The first metal layer is provided on a side of the insulating separation layer facing the second electrode plate group, and the second metal layer is provided on a side of the insulating separation layer facing away from the second electrode plate group.

In one or more optional embodiments, the current collector of the first electrode plate includes an insulating separation layer, a first metal layer, and a second metal layer, where the insulating separation layer serves as a mechanical performance support framework for the current collector to provide good mechanical properties for the current collector. This allows the thickness of the first metal layer and the second metal layer to be smaller, reducing metal burrs caused by mechanical damage to the first electrode plate, thereby improving the safety performance of the battery cell.

In some embodiments of the first aspect of the present application, a material of the packaging member is the same as a material of the first metal layer.

In one or more optional embodiments, the material of the packaging member being the same as the material of the first metal layer avoids excessive electrode potential differences between the packaging member and the second region, thereby reducing the risk of electrochemical corrosion, which is beneficial to improving the safety performance of the battery cell and extending the service life of the battery cell.

In some embodiments of the first aspect of the present application, the material of the packaging member is different from the material of the first metal layer. The battery cell further includes an insulating layer, where, along the first direction, the insulating layer is provided between a surface of the second region facing the second electrode plate group and the packaging member to separate the packaging member and the second region.

In one or more optional embodiments, the material of the packaging member being different from the material of the first metal layer allows for selection of respective optimal materials for the packaging member and the current collector, resulting in better performance of both the packaging member and the current collector. When the material of the packaging member is different from the material of the first metal layer, the insulating layer being provided between the packaging member and the second region of the current collector separates the packaging member and the second region, reducing the risk of electrochemical corrosion due to excessive electrode potential differences between the packaging member and the second region, which is beneficial to improving the safety performance of the battery cell and extending the service life of the battery cell.

In some embodiments of the first aspect of the present application, the insulating layer is provided in the second region.

In one or more optional embodiments, the insulating layer being provided in the second region of the current collector can separate the second region and the packaging member in the first direction, reducing the risk of electrochemical corrosion due to excessive electrode potential differences between the packaging member and the second region, which is beneficial to improving the safety performance of the battery cell and extending the service life of the battery cell. Since the side of the second region facing the second electrode plate group is not provided with the active material layer, the insulating layer being provided in the second region can also mitigate the problems of warping and curling of the first electrode plate in the second region.

In some embodiments of the first aspect of the present application, a thickness of the current collector is denoted as H, where 0.003 mm≤H≤0.030 mm.

In one or more optional embodiments, the current collector of the first electrode plate being greater than or equal to 0.003 mm ensures good mechanical and electrical conductivity properties of the current collector. The current collector of the first electrode plate being less than or equal to 0.030 mm keeps the thickness of the current collector of the first electrode plate within a reasonable range, reducing the space occupied by the current collector of the first electrode plate, thereby reducing the energy density loss of the battery cell and facilitating an increase in the energy density of the battery cell.

In some embodiments of the first aspect of the present application, 0.004 mm≤H≤0.020 mm.

In one or more optional embodiments, the current collector of the first electrode plate being greater than or equal to 0.004 mm provides better mechanical and electrical conductivity properties of the current collector. The current collector of the first electrode plate being less than or equal to 0.020 mm keeps the thickness of the current collector of the first electrode plate within a reasonable range, further reducing the space occupied by the current collector of the first electrode plate, thereby further reducing the energy density loss of the battery cell and further increasing the energy density of the battery cell.

In some embodiments of the first aspect of the present application, the packaging member includes a main body portion, where the main body portion includes a first main body portion and a second main body portion. The first main body portion and the second main body portion are arranged side by side along the second direction. The second main body portion has a first outer surface in the first direction, and the first main body portion protrudes from the first outer surface. When observed along the first direction, the first electrode plate group includes a first portion overlapping with the second electrode plate group and a second portion not overlapping with the second electrode plate group, where the first portion and the second portion are arranged along the second direction and connected. The first portion and the second electrode plate group are accommodated in the second main body portion, and the second portion is accommodated in the first main body portion.

In one or more optional embodiments, the main body portion includes the first main body portion and the second main body portion, where the first main body portion and the second main body portion are arranged side by side along the second direction. The second main body portion has the first outer surface in the first direction, and the first main body portion protrudes from the first outer surface. The first portion and the second electrode plate group are accommodated in the second main body portion, and the second portion is accommodated in the first main body portion, enabling the structural form of the electrode assembly to match the structural form of the packaging member, which facilitates full utilization of the internal space of the packaging member and reduces energy density loss.

According to a second aspect, an embodiment of the present application provides an electric device including the battery cell provided in any of the foregoing embodiments.

### DETAILED DESCRIPTION

To more clearly illustrate the technical solutions of some embodiments of the present application, the drawings required for use in these embodiments are briefly introduced below. It should be understood that the following drawings only show some certain embodiments of the present application and should not be regarded as limiting the scope.

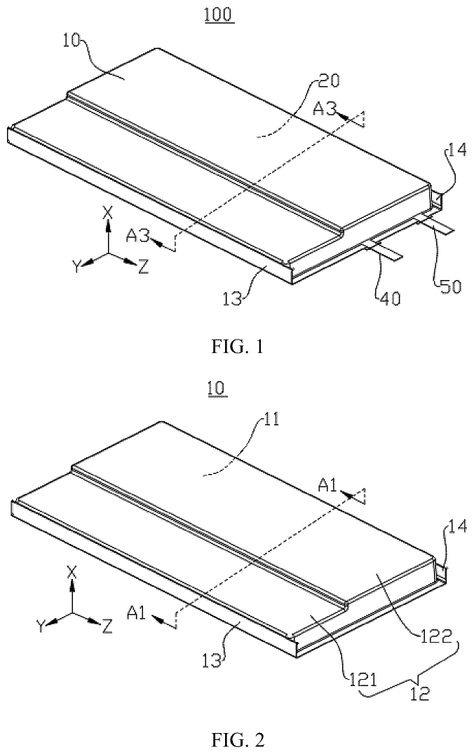

FIG. 1 is a schematic structural diagram of a battery cell according to some embodiments of the present application.

FIG. 2 is a schematic structural diagram of a packaging member according to some embodiments of the present application.

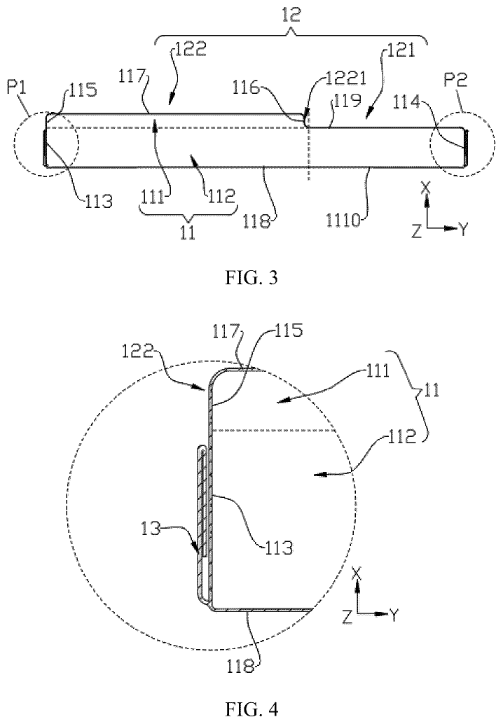

FIG. 3 is a cross-sectional view taken along line A1-A1 in FIG. 2.

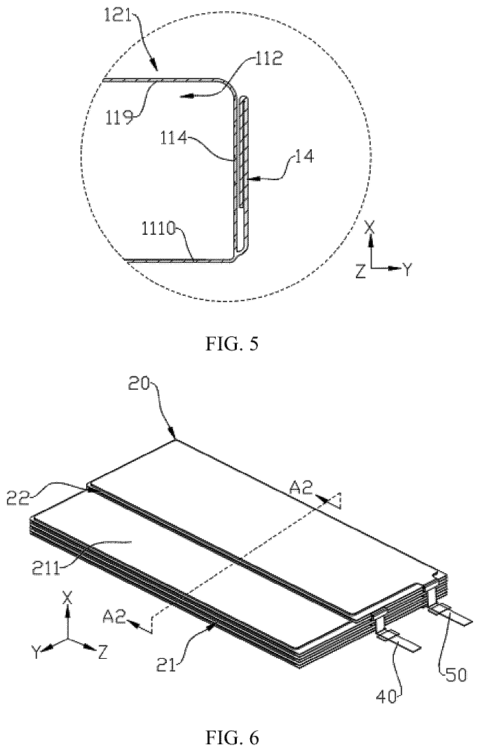

FIG. 4 is an enlarged view at P1 in FIG. 3.

FIG. 5 is an enlarged view at P2 in FIG. 3.

FIG. 6 is a schematic structural diagram of an electrode assembly according to some embodiments of the present application.

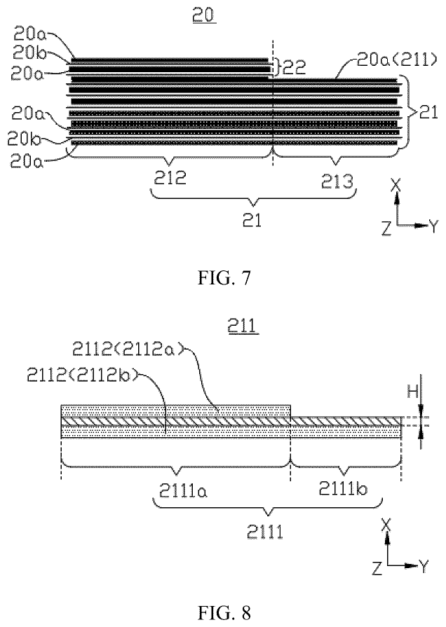

FIG. 7 is a cross-sectional view taken along line A2-A2 in FIG. 6.

FIG. 8 is a schematic structural diagram of a first electrode plate according to some embodiments of the present application.

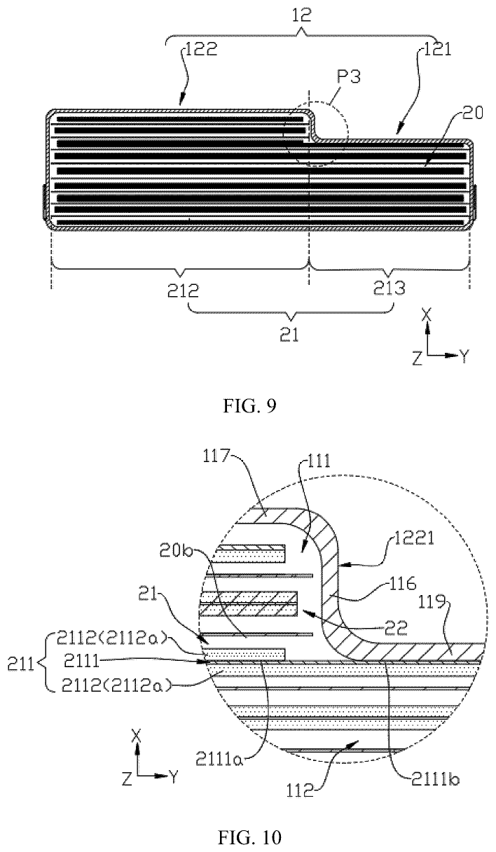

FIG. 9 is a cross-sectional view taken along line A3-A3 in FIG. 1.

FIG. 10 is an enlarged view at P3 in FIG. 9.

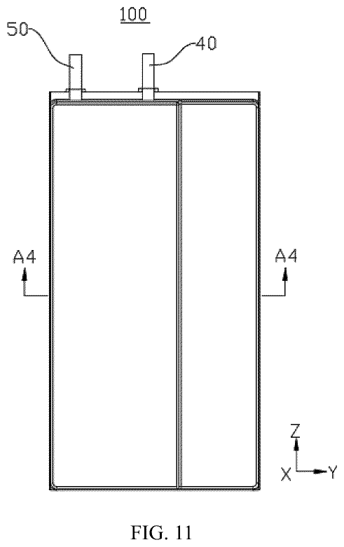

FIG. 11 is a schematic structural diagram of a battery cell according to some other embodiments of the present application.

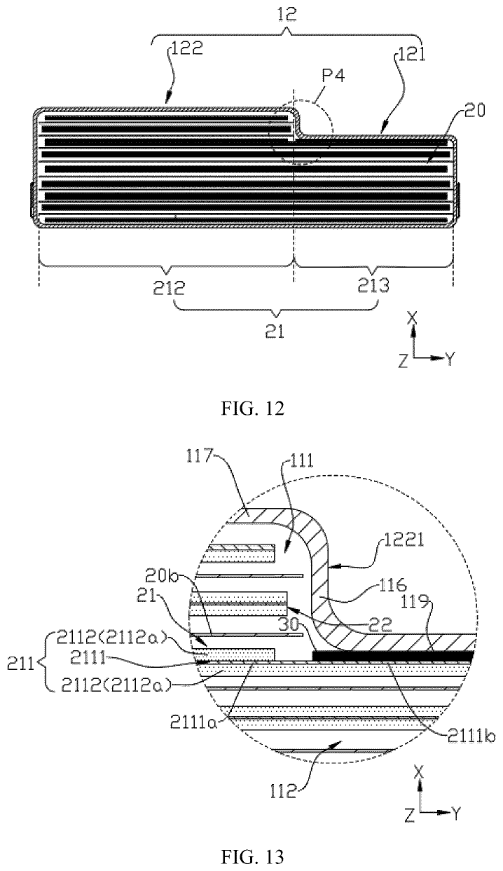

FIG. 12 is a cross-sectional view taken along line A4-A4 in FIG. 11.

FIG. 13 is an enlarged view at P4 in FIG. 12.

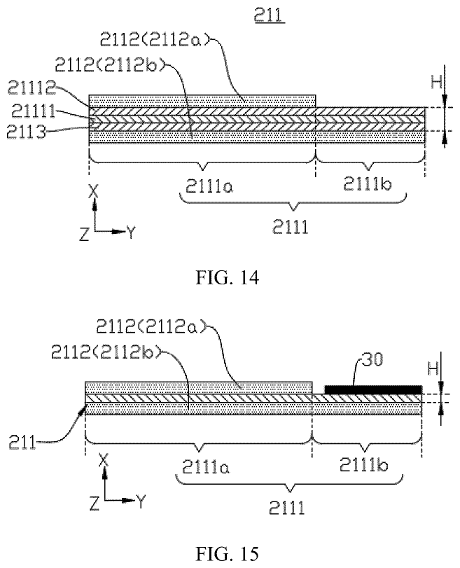

FIG. 14 is a schematic structural diagram of a first electrode plate according to some other embodiments of the present application.

FIG. 15 is a schematic diagram showing the first electrode plate in FIG. 12 provided with an insulating layer.

Reference signs: 100. battery cell; 10. packaging member; 11. accommodation cavity; 111. first accommodation cavity; 112. second accommodation cavity; 113. first wall portion; 114. second wall portion; 115. third wall portion; 116. fourth wall portion; 117. fifth wall portion; 118. sixth wall portion; 119. seventh wall portion; 1110. eighth wall portion; 12. main body portion; 121. first main body portion; 122. second main body portion; 1221. first outer surface; 13. first sealing portion; 14. second sealing portion; 20. electrode assembly; 20a. electrode plate; 20b. separator; 21. first electrode plate group; 211. first electrode plate; 2111. current collector; 2111a. first region; 2111b. second region; 21111. insulating separation layer; 21112. first metal layer; 2113. second metal layer; 2112. active material layer; 2112a. first active material layer; 2112b. second active material layer; 212. first portion; 213. second portion; 22. second electrode plate group; 30. insulating layer; 40. positive electrode tab; 50. negative electrode tab; X. first direction; Y. second direction; and Z. third direction.

### DESCRIPTION OF EMBODIMENTS

To make the objectives, technical solutions, and advantages of some embodiments of the present application clearer, the technical solutions in these embodiments of the present application are described clearly and completely below with reference to the drawings in these embodiments of the present application. Apparently, the described embodiments are some, but not all, embodiments of the present application. Generally, the components in some embodiments of the present application as described and illustrated in the accompanying drawings herein can be arranged and designed in a variety of configurations.

It should be noted that, in the absence of conflict, some embodiments and features in these embodiments of the present application may be combined with each other.

It should be noted that similar reference numerals and letters indicate similar items in the following drawings, and therefore, once an item is defined in one drawing, it does not need to be further defined or explained in subsequent drawings.

In the description of some embodiments of the present application, it should be noted that indications of orientation or positional relationships are based on the orientations or positional relationships shown in the drawings, or the usual orientations or positional relationships when the product of the present application is used, or the orientations or positional relationships commonly understood by those skilled in the art. These are merely for convenience in describing the present application and simplifying the description, and do not indicate or imply that the referred apparatus or element must have a specific orientation, be constructed, or operate in a specific orientation, and thus should not be construed as limiting the present application. Additionally, the terms “first,” “second,” “third,” and the like are merely used for distinguishing purposes and should not be understood as indicating or implying relative importance.

Currently, from the perspective of market development, battery cells have been increasingly widely used. Battery cells have been widely applied in many fields, such as electric transportation tools including electric bicycles, electric motorcycles, and electric vehicles, electric tools, unmanned aerial vehicles, and energy storage devices. With the continuous expansion of application fields of battery cells, market demands for battery cells are also increasing.

Battery cells include wound battery cells and laminated battery cells. The electrode assembly of a laminated battery cell includes multiple electrode plates with opposite polarities alternately stacked. A stepped battery cell is a type of laminated battery cell, and the electrode assembly of the stepped battery cell includes at least a first electrode plate group and a second electrode plate group, where the first electrode plate group and the second electrode plate group are stacked along a first direction. Along a second direction, a length of the first electrode plate group is greater than a length of the second electrode plate group, and the second direction is perpendicular to the first direction. The first electrode plate group includes multiple electrode plates stacked along the first direction X, where the two electrode plates farthest apart in the first direction in the first electrode plate group are electrode plates coated with an active material layer on a single surface. The second electrode plate group includes multiple electrode plates stacked along the first direction, where the two electrode plates farthest apart in the first direction in the second electrode plate group are electrode plates coated with the active material layer on a single surface. The electrode plate coated with the active material layer on a single surface of the first electrode plate group closest to the second electrode plate group and the electrode plate coated with the active material layer on a single surface of the second electrode plate group closest to the first electrode plate group are bonded via an adhesive layer, resulting in a significant energy density loss of the stepped battery cell in the first direction, thus leading to a lower energy density of the battery cell.

Based on the above considerations, to reduce the energy density loss of the battery cell and increase the energy density of the battery cell, an embodiment of the present application provides a battery cell, where the battery cell includes a packaging member and an electrode assembly, and the electrode assembly is accommodated within the packaging member. The electrode assembly is a laminated structure. The electrode assembly includes a first electrode plate group and a second electrode plate group, where the first electrode plate group and the second electrode plate group are stacked along a first direction. Along a second direction, a length of the first electrode plate group is greater than a length of the second electrode plate group, and the second direction is perpendicular to the first direction. The first electrode plate group includes a first electrode plate closest to the second electrode plate group, where the first electrode plate includes a current collector and an active material layer, the current collector includes a first region and a second region. Along a thickness direction of the current collector, both sides of the first region are provided with the active material layer, while the second region is provided with the active material layer only on a side facing away from the second electrode plate group. The first region at least partially overlaps with the first electrode plate group, and the second region at least partially does not overlap with the first electrode plate group.

A dimension of the first electrode plate group in the second direction is greater than a dimension of the second electrode plate group in the second direction. The first electrode plate group includes the first electrode plate closest to the second electrode plate group, where the current collector of the first electrode plate includes the first region at least partially overlapping with the second electrode plate group and the second region at least partially not overlapping with the second electrode plate group. Both sides of the first region are provided with the active material layer, and the active material layer on the side of the first region facing the second electrode plate group can serve as an outermost electrode plate of the second electrode plate group, which is equivalent to a scheme where an outermost electrode plate of the second electrode plate group and an outermost electrode plate of the first electrode plate group share one current collector. Compared with a scheme where a current collector of an outermost electrode plate coated with the active material layer on a single surface of the first electrode plate group and a current collector of an outermost electrode plate coated with the active material layer on a single surface of the second electrode plate group are bonded via an adhesive layer, this scheme reduces the space occupied by the adhesive layer, thereby reducing the energy density loss of the battery cell in the first direction. Compared with the scheme where a current collector of an outermost electrode plate coated with the active material layer on a single surface of the first electrode plate group and a current collector of an outermost electrode plate coated with the active material layer on a single surface of the second electrode plate group are bonded via an adhesive layer, this scheme, by providing the first electrode plate, reduces the number of electrode plates coated with the active material layer on a single surface in the battery cell, thereby reducing the number of current collectors in the battery cell and further reducing the energy density loss of the battery cell in the first direction. Additionally, to mitigate the problems of warping and curling of the electrode plates coated with the active material layer on a single surface, the current collector of the electrode plate with single-surface coating is thick, which also leads to energy density loss of the battery cell. In this scheme, both sides of the first region of the current collector of the first electrode plate in the battery cell are provided with the active material layer, and the active material layers on both sides of the first region of the current collector of the first electrode plate can counteract stress, reducing the risk of warping and curling of the first electrode plate. This also allows the thickness of the current collector of the first electrode plate relative to the current collector of an electrode plate coated with the active material layer on a single surface to be smaller, further reducing the energy density loss of the battery cell in the first direction. Furthermore, the second region of the current collector of the first electrode plate is provided with the active material layer only on the side facing away from the second electrode plate group, reducing the use of active material that does not contribute to capacity and avoiding the space occupied by such active material, further reducing the energy density loss of the battery cell in the first direction. Therefore, compared with the scheme where an electrode plate coated with the active material layer on a single surface of the first electrode plate group closest to the second electrode plate group and an electrode plate coated with the active material layer on a single surface of the second electrode plate group closest to the first electrode plate group are bonded via an adhesive layer, the battery cell of this scheme has a higher energy density.

The battery cell disclosed in some embodiments of the present application can be used, but is not limited to, in electric devices such as electric two-wheelers, electric tools, unmanned aerial vehicles, and energy storage devices. Battery cells manufactured with electrode plates under the conditions of the present application can also be used as a power system for electric devices.

An embodiment of the present application provides an electric device that uses a battery cell as a power source. The electric device may be, but is not limited to, an electronic device, an electric tool, an electric transportation tool, an unmanned aerial vehicle, or an energy storage device. The electronic device may include a mobile phone, a tablet computer, a notebook computer, or the like; the electric tool may include an electric drill, an electric saw, or the like; and the electric transportation tool may include an electric vehicle, an electric motorcycle, an electric bicycle, or the like.

As shown in FIG. 1 and FIG. 2, an embodiment of the present application provides a battery cell 100, where the battery cell 100 includes a packaging member 10 and an electrode assembly 20. The electrode assembly 20 is accommodated within the packaging member 10.

The packaging member 10 may be a rigid shell, for example, the packaging member 10 may be a stainless steel shell or an aluminum hard shell, forming a steel shell battery or an aluminum shell battery.

The packaging member 10 may also be formed of a softer material, for example, the packaging member 10 may be an aluminum-plastic film or a steel-plastic film, forming a pouch battery cell 100.

As shown in FIG. 2 and FIG. 3, the packaging member 10 internally forms an accommodation cavity 11. The electrode assembly 20 is accommodated within the accommodation cavity 11. In some embodiments, the accommodation cavity 11 includes a first accommodation cavity 111 and a second accommodation cavity 112. The first accommodation cavity 111 and the second accommodation cavity 112 are arranged along the first direction X, and along the second direction Y, a length of the second accommodation cavity 112 is greater than a length of the first accommodation cavity 111. As shown in FIG. 3, along the second direction Y, one end of the first accommodation cavity 111 is flush with one end of the second accommodation cavity 112, and the other end of the second accommodation cavity 112 extends beyond the other end of the first accommodation cavity 111. Specifically, the packaging member 10 includes a first wall portion 113 and a second wall portion 114 opposite each other along the second direction Y, where the second accommodation cavity 112 is located between a surface of the first wall portion 113 and an inner surface of the second wall portion 114. The packaging member 10 includes a third wall portion 115 and a fourth wall portion 116 opposite each other along the second direction Y, where the first accommodation cavity 111 is located between an inner surface of the third wall portion 115 and an inner surface of the fourth wall portion 116. The inner surface of the first wall portion 113 and the inner surface of the third wall portion 115 are parallel and connected. Along the second direction Y, the inner surface of the second wall portion 114 is farther from the inner surface of the first wall portion 113 than the inner surface of the fourth wall portion 116, such that one end of the first accommodation cavity 111 is flush with one end of the second accommodation cavity 112, and the second accommodation cavity 112 extends beyond the first accommodation cavity 111 in the direction from the first wall portion 113 to the second wall portion 114. The second direction Y is perpendicular to the first direction X. The first direction X may be the thickness direction of the battery cell 100. It should be noted that in FIG. 4, the dashed line parallel to the second direction Y is used to illustrate the boundary between the first accommodation cavity 111 and the second accommodation cavity 112 in the first direction X for ease of understanding the structure and should not be construed as limiting the structure of the packaging member 10.

As shown in FIG. 2 and FIG. 3, in some embodiments, the packaging member 10 includes a main body portion 12, where the main body portion 12 includes a first main body portion 121 and a second main body portion 122. The first main body portion 121 and the second main body portion 122 are arranged side by side along the second direction Y. The second main body portion 122 has a first outer surface 1221 in the first direction X, and the first main body portion 121 protrudes from the first outer surface 1221.

It should be noted that in FIG. 3, the dashed line parallel to the first direction X is used to illustrate the boundary between the first main body portion 121 and the second main body portion 122 in the second direction Y for ease of understanding the structure and should not be construed as limiting the structure of the packaging member 10.

The first wall portion 113, the third wall portion 115, and the fourth wall portion 116 are wall portions of the second main body portion 122. The second main body portion 122 further includes a fifth wall portion 117 and a sixth wall portion 118 opposite each other along the first direction X.

The second wall portion 114 is a wall portion of the first main body portion 121. The first main body portion 121 further includes a seventh wall portion 119 and an eighth wall portion 1110 opposite each other along the first direction X. The inner surface of the sixth wall portion 118 and the inner surface of the eighth wall portion 1110 are parallel and connected. The sixth wall portion 118 and the eighth wall portion 1110 may be integrally formed. The fifth wall portion 117 is farther from the sixth wall portion 118 along the first direction X than the seventh wall portion 119. The fifth wall portion 117 and the seventh wall portion 119 are connected via the fourth wall portion 116, such that the first main body portion 121 protrudes from an outer surface of the fourth wall portion 116 in the second direction Y, where the outer surface of the fourth wall portion 116 is the first outer surface 1221 of the second main body portion 122 in the first direction X. The outer surface (first outer surface 1221) of the fourth wall portion 116 in the second direction Y is a stepped surface, and the battery cell 100 is a stepped battery.

The third wall portion 115, the fourth wall portion 116, and the fifth wall portion 117 are partial wall portions defining the first accommodation cavity 111. The first wall portion 113 and the sixth wall portion 118 of the second main body portion 122, as well as the second wall portion 114, the seventh wall portion 119, and the eighth wall portion 1110 of the first main body portion 121, are partial wall portions defining the second accommodation cavity 112. The contour of the main body portion 12 matches the contour shape of the accommodation cavity 11.

As shown in FIG. 4, in some embodiments, the packaging member 10 further includes a first sealing portion 13, where the first sealing portion 13 is connected to a side of the second main body portion 122 facing away from the first main body portion 121. The first sealing portion 13 can be folded around an axis parallel to the third direction Z to adhere to the side of the second main body portion 122 facing away from the first main body portion 121, reducing the dimension of the battery cell 100 in the second direction Y and improving space utilization. The first direction X, the second direction Y, and the third direction Z are pairwise perpendicular.

As shown in FIG. 5, in some embodiments, the packaging member 10 further includes a second sealing portion 14, where the second sealing portion 14 is connected to a side of the first main body portion 121 facing away from the second main body portion 122. The second sealing portion 14 can be folded around an axis parallel to the third direction Z to adhere to the side of the first main body portion 121 facing away from the second main body portion 122, reducing the dimension of the battery cell 100 in the second direction Y and improving space utilization.

As shown in FIG. 6 and FIG. 7, the electrode assembly 20 is a laminated structure. The electrode assembly 20 includes a first electrode plate group 21 and a second electrode plate group 22, where the first electrode plate group 21 and the second electrode plate group 22 are stacked along the first direction X. Along the second direction Y, a length of the first electrode plate group 21 is greater than a length of the second electrode plate group 22.

The first electrode plate group 21 includes multiple electrode plates 20a stacked along the first direction X. Two adjacent electrode plates 20a in the first electrode plate group 21 have opposite polarities, meaning that one of the two adjacent electrode plates 20a in the first electrode plate group 21 is a positive electrode plate, and the other is a negative electrode plate. A separator 20b is provided between two adjacent electrode plates 20a in the first electrode plate group 21, where the separator 20b is configured to insulate and separate two adjacent electrode plates 20a with opposite polarities in the first electrode plate group 21. The first electrode plate group 21 includes a first outer electrode plate farthest from the second electrode plate group 22, where the first outer electrode plate 20a may be an electrode plate coated with the active material layer on a single surface, which helps reduce the use of active material that does not contribute to capacity, thereby increasing the energy density of the battery cell 100. Alternatively, the first outer electrode plate may be an electrode plate coated with the active material on two surfaces. The first outer electrode plate may be a positive electrode plate or a negative electrode plate.

The second electrode plate group 22 includes multiple electrode plates 20a stacked along the first direction X. Two adjacent electrode plates 20a in the second electrode plate group 22 have opposite polarities, meaning that one of the two adjacent electrode plates 20a in the second electrode plate group 22 is a positive electrode plate, and the other is a negative electrode plate. A separator 20b is provided between two adjacent electrode plates 20a in the second electrode plate group 22, where the separator 20b is configured to insulate and separate two adjacent electrode plates 20a with opposite polarities in the second electrode plate group 22. The second electrode plate group 22 includes a second outer electrode plate farthest from the first electrode plate group 21, where the second outer electrode plate may be an electrode plate coated with the active material layer on a single surface, which helps reduce the use of active material that does not contribute to capacity, thereby increasing the energy density of the battery cell 100. Alternatively, the second outer electrode plate may be an electrode plate coated with the active material on two surfaces. The second outer electrode plate may be a positive electrode plate or a negative electrode plate.

The first electrode plate group 21 and the second electrode plate group 22 are insulated and separated by a separator 20b.

The separator 20b insulates and separates two electrode plates 20a with opposite polarities, reducing the risk of short circuits in the battery cell 100. The material of the separator 20b may include PP (polypropylene, polypropylene) or PE (polyethylene, polyethylene), and the like.

A positive electrode plate includes a positive electrode current collector and a positive electrode active material layer, where at least one side of the positive electrode current collector is provided with the positive electrode active material layer. The material of the positive electrode current collector may include aluminum, and the positive electrode active material may be lithium cobalt oxide, lithium iron phosphate, ternary lithium, or lithium manganese oxide, or the like. A negative electrode plate includes a negative electrode current collector and a negative electrode active material layer, where at least one side of the negative electrode current collector is provided with the negative electrode active material layer. The material of the negative electrode current collector may include copper, and the negative electrode active material may be carbon, silicon, or the like.

As shown in FIG. 6, FIG. 7, and FIG. 8, the first electrode plate group 21 includes a first electrode plate 211 closest to the second electrode plate group 22, where the first electrode plate 211 includes a current collector 2111 and an active material layer 2112. The current collector 2111 includes a first region 2111a at least partially overlapping with the second electrode plate group 22 and a second region 2111b at least partially not overlapping with the second electrode plate group 22. Both sides of the first region 2111a are provided with the active material layer 2112, while the second region 2111b is provided with the active material layer 2112 only on a side facing away from the second electrode plate group 22.

In FIG. 7, the dashed line parallel to the first direction X represents the boundary between the first region 2111a and the second region 2111b of the first current collector 2111, and also represents the boundary between the first portion 212 and the second portion 213 described later.

A dimension of the first electrode plate group 21 in the second direction Y is greater than a dimension of the second electrode plate group 22 in the second direction Y. The first electrode plate group 21 includes the first electrode plate 211 closest to the second electrode plate group 22, where the current collector 2111 of the first electrode plate 211 includes the first region 2111a at least partially overlapping with the second electrode plate group 22 and the second region 2111b at least partially not overlapping with the second electrode plate group 22. Both sides of the first region 2111a are provided with the active material layer 2112, and the active material layer 2112 on the side of the first region 2111a facing the second electrode plate group 22 can serve as an outermost electrode plate of the second electrode plate group 22, which is equivalent to a scheme where an outermost electrode plate 20a of the second electrode plate group 22 and an outermost electrode plate 20a of the first electrode plate group 21 share one current collector 2111. Compared with a scheme where a current collector of an outermost electrode plate coated with the active material layer 2112 on a single surface of the first electrode plate group 21 and a current collector of an outermost electrode plate coated with the active material layer on a single surface of the second electrode plate group 22 are bonded via an adhesive layer, this scheme reduces the space occupied by the adhesive layer, thereby reducing the energy density loss of the battery cell 100 in the first direction X. Compared with the scheme where a current collector of an outermost electrode plate coated with the active material layer on a single surface of the first electrode plate group 21 and a current collector of an outermost electrode plate coated with the active material layer on a single surface of the second electrode plate group 22 are bonded via an adhesive layer, this scheme, by providing the first electrode plate 211, reduces the number of electrode plates coated with the active material layer on a single surface in the battery cell 100, thereby reducing the number of current collectors 2111 in the battery cell 100 and further reducing the energy density loss of the battery cell 100 in the first direction X. Additionally, to mitigate the problems of warping and curling of the electrode plates coated with the active material layer on a single surface, the current collector of the electrode plate coated with the active material on a single surface is thick, which also leads to energy density loss of the battery cell 100. In this scheme, both sides of first region 2111a of the current collector 2111 of the first electrode plate 211 in the battery cell 100 are provided with the active material layer 2112, and the active material layers 2112 on both sides of the first region 2111a of the current collector 2111 of the first electrode plate 211 can counteract stress, reducing the risk of warping and curling of the first electrode plate 211. This also allows the thickness of the current collector 2111 of the first electrode plate 211 relative to the current collector of an electrode plate coated with the active material layer on a single surface to be smaller, further reducing the energy density loss of the battery cell 100 in the first direction X. Furthermore, the second region 2111b of the current collector 2111 of the first electrode plate 211 is provided with the active material layer 2112 only on the side facing away from the second electrode plate group 22, reducing the use of active material that does not contribute to capacity and avoiding the space occupied by such active material, further reducing the energy density loss of the battery cell 100 in the first direction X. Therefore, compared with the scheme where an electrode plate 20a coated with the active material layer on a single surface of the first electrode plate group 21 closest to the second electrode plate group 22 and an electrode plate 20a coated with the active material layer on a single surface of the second electrode plate group 22 closest to the first electrode plate group 21 are bonded via an adhesive layer, the battery cell 100 of this scheme has a higher energy density.

Referring to FIG. 7, FIG. 9, and FIG. 10, when observed along the first direction X, the first electrode plate group 21 includes a first portion 212 overlapping with the second electrode plate group 22 and a second portion 213 not overlapping with the second electrode plate group 22, where the first portion 212 and the second portion 213 are arranged along the second direction Y and connected. The first portion 212 and the second electrode plate group 22 are accommodated in the second main body portion 122, and the second portion 213 is accommodated in the first main body portion 121.

In FIG. 9, the dashed line parallel to the first direction X is used to illustrate the boundary between the first portion 212 and the second portion 213 in the second direction Y for ease of understanding the structure and should not be construed as limiting the structure of the battery cell 100.

A polarity of the active material layer 2112 on the side of the current collector 2111 of the first electrode plate 211 facing the second electrode plate group 22 is opposite to a polarity of the electrode plate 20a of the second electrode plate group 22 closest to the first electrode plate group 21. For example, if the electrode plate 20a of the second electrode plate group 22 closest to the first electrode plate group 21 is a positive electrode plate, the active material layer 2112 on the side of the current collector 2111 facing the second electrode plate group 22 is a negative electrode active material layer. If the electrode plate 20a of the second electrode plate group 22 closest to the first electrode plate group 21 is a negative electrode plate, the active material layer 2112 on the side of the current collector 2111 facing the second electrode plate group 22 is a positive electrode active material layer.

A polarity of the active material layer 2112 on the side of the current collector 2111 of the first electrode plate 211 facing away from the second electrode plate group 22 is opposite to a polarity of the electrode plate 20a of the first electrode plate group 21 closest to the first electrode plate 211. For example, if the electrode plate 20a of the first electrode plate group 21 closest to the first electrode plate 211 is a positive electrode plate, the active material layer 2112 on the side of the current collector 2111 facing away from the second electrode plate group 22 is a negative electrode active material layer. If the electrode plate 20a of the second electrode plate group 22 closest to the first electrode plate 211 is a negative electrode plate, the active material layer 2112 on the side of the current collector 2111 facing away from the second electrode plate group 22 is a positive electrode active material layer.

The active material layer 2112 includes a first active material layer 2112a provided on a side of the current collector 2111 facing the second electrode plate group 22 and a second active material layer 2112b provided on a side of the current collector 2111 facing away from the second electrode plate group 22. At least a portion of the first active material layer 2112a and the second electrode plate group 22 are accommodated in the first accommodation cavity 111, while the current collector 2111 and the second active material layer 2112b are accommodated in the second accommodation cavity 112.

At least a portion of the first active material layer 2112a and the second electrode plate group 22 are accommodated in the first accommodation cavity 111, while the current collector 2111 and the second active material layer 2112b are accommodated in the second accommodation cavity 112, fully utilizing the space within the packaging member 10 in the first direction X and reducing the gap between the first electrode plate group 21 and the second electrode plate group 22 and the inner wall of the packaging member 10 in the first direction X, which is beneficial to increasing the energy density of the battery cell 100.

A polarity of the first active material layer 2112a is opposite to a polarity of the electrode plate 20a of the second electrode plate group 22 closest to the first electrode plate group 21. A polarity of the second active material layer 2112b is opposite to a polarity of the electrode plate 20a of the first electrode plate group 21 closest to the first electrode plate 211.

The second electrode plate group 22 is entirely located within the first accommodation cavity 111.

As shown in FIG. 9 and FIG. 10, in some embodiments, the first active material layer 2112a may alternatively be entirely located within the first accommodation cavity 111 along the first direction X. When observed along the second direction Y, a projection of the first active material layer 2112a is within a projection of the fourth wall portion 116. In embodiments where the first active material layer 2112a may alternatively be entirely located within the first accommodation cavity 111 along the first direction X, a surface of the first active material layer 2112a facing the current collector 2111 may be flush with an inner surface of the seventh wall portion 119. In embodiments where the first active material layer 2112a may alternatively be entirely located within the first accommodation cavity 111 along the first direction X, the surface of the first active material layer 2112a facing the current collector 2111 may be farther from an inner surface of the eighth wall portion 1110 than the inner surface of the seventh wall portion 119.

As shown in FIG. 9 and FIG. 10, in some embodiments, a surface of the second region 2111b facing away from the second active material layer 2112b may adhere to a wall portion (seventh wall portion) of the packaging member 10, such that the first active material layer 2112a is entirely located within the first accommodation cavity 111, avoiding a gap in the first direction X between the wall portion of the packaging member 10 and the surface of the second region 2111b facing away from the second active material layer 2112b, improving space utilization, and facilitating an increase in the energy density of the battery cell 100.

As shown in FIG. 11, FIG. 12, and FIG. 13, in some other embodiments, a portion of the first active material layer 2112a along the first direction X is located within the first accommodation cavity 111, and another portion of the first active material layer 2112a along the first direction X is located within the second accommodation cavity 112. When observed along the second direction Y, a projection of an inner surface of a wall portion (seventh wall portion 119) of the packaging member 10 opposite the second region 2111b in the first direction X is within a projection of the first active material layer 2112a.

As shown in FIG. 8, in some embodiments, a thickness of the current collector 2111 is denoted as H, where 0.003 mm≤H≤0.030 mm.

The thickness of the current collector 2111 is the distance between two opposite surfaces of the current collector 2111 in the first direction X. For example, H may be 0.003 mm, 0.004 mm, 0.005 mm, 0.006 mm, 0.007 mm, 0.009 mm, 0.011 mm, 0.013 mm, 0.015 mm, 0.017 mm, 0.019 mm, 0.021 mm, 0.023 mm, 0.025 mm, 0.027 mm, 0.030 mm, or the like.

The thickness of the current collector 2111 of the first electrode plate 211 being greater than or equal to 0.003 mm ensures good mechanical and electrical conductivity properties of the current collector 2111. The current collector 2111 of the first electrode plate 211 being less than or equal to 0.030 mm keeps the thickness of the current collector 2111 of the first electrode plate 211 within a reasonable range, reducing the space occupied by the current collector 2111 of the first electrode plate 211, thereby reducing the energy density loss of the battery cell 100 and facilitating an increase in the energy density of the battery cell 100.

Further, 0.004 mm≤H≤0.020 mm.

For example, H may be 0.004 mm, 0.005 mm, 0.006 mm, 0.008 mm, 0.010 mm, 0.012 mm, 0.014 mm, 0.016 mm, 0.018 mm, 0.020 mm, or the like.

The thickness of the current collector 2111 of the first electrode plate 211 being greater than or equal to 0.004 mm provides better mechanical and electrical conductivity properties of the current collector 2111. The current collector 2111 of the first electrode plate 211 being less than or equal to 0.020 mm keeps the thickness of the current collector 2111 of the first electrode plate 211 within a reasonable range, further reducing the space occupied by the current collector 2111 of the first electrode plate 211, thereby further reducing the energy density loss of the battery cell 100 and further increasing the energy density of the battery cell 100.

As shown in FIG. 8, in some embodiments, the current collector 2111 is a first metal layer 21112. It can be understood that the current collector 2111 may be a foil. The current collector 2111 of the first electrode plate 211 being a metal layer ensures good electrical conductivity of the current collector 2111.

In embodiments where the first current collector 2111 is the first metal layer 21112, polarities of the active material layers 2112 on both sides of the current collector 2111 of the first electrode plate 211 may be the same, meaning that the first active material layer 2112a and the second active material layer 2112b have the same polarities. The first active material layer 2112a and the second active material layer 2112b may both be positive electrode active material layers, meaning that the first electrode plate 211 may be a positive electrode plate. The first active material layer 2112a and the second active material layer 2112b may both be negative electrode active material layers, meaning that the first electrode plate 211 may also be a negative electrode plate.

As shown in FIG. 14, in some embodiments, the current collector 2111 includes an insulating separation layer 21111, a first metal layer 21112, and a second metal layer 2113. The first metal layer 21112 is provided on a side of the insulating separation layer 21111 facing the second electrode plate group 22, and the second metal layer 2113 is provided on a side of the insulating separation layer 21111 facing away from the second electrode plate group 22. It can be understood that the current collector 2111, including the insulating separation layer 21111, the first metal layer 21112, and the second metal layer 2113, is a composite current collector.

The current collector 2111 of the first electrode plate 211 includes the insulating separation layer 21111, the first metal layer 21112, and the second metal layer 2113, where the insulating separation layer 21111 serves as a mechanical performance support framework for the current collector 2111 to provide good mechanical properties for the current collector 2111. This allows the thickness of the first metal layer 21112 and the second metal layer 2113 to be smaller, reducing metal burrs caused by mechanical damage to the first electrode plate 211, thereby improving the safety performance of the battery cell 100.

In embodiments where the current collector 2111 includes the insulating separation layer 21111, the first metal layer 21112, and the second metal layer 2113, the thickness of the current collector 2111 is the distance along the first direction X between a surface of the first metal layer 21112 facing away from the insulating separation layer 21111 and a surface of the second metal layer 2113 facing away from the insulating separation layer 21111.

In embodiments where the current collector 2111 includes the insulating separation layer 21111, the first metal layer 21112, and the second metal layer 2113, polarities of the active material layers 2112 on both sides of the current collector 2111 of the first electrode plate 211 may be the same, meaning that the first active material layer 2112a and the second active material layer 2112b have the same polarities. The first active material layer 2112a and the second active material layer 2112b may both be positive electrode active material layers, meaning that the first electrode plate 211 may be a positive electrode plate. The first active material layer 2112a and the second active material layer 2112b may both be negative electrode active material layers, meaning that the first electrode plate 211 may also be a negative electrode plate.

In embodiments where the current collector 2111 includes the insulating separation layer 21111, the first metal layer 21112, and the second metal layer 2113, polarities of the active material layers 2112 on both sides of the current collector 2111 of the first electrode plate 211 may be opposite, meaning that the first active material layer 2112a and the second active material layer 2112b have opposite polarities, where one of the first active material layer 2112a and the second active material layer 2112b is a positive electrode active material layer, and the other of the first active material layer 2112a and the second active material layer 2112b is a negative electrode active material layer.

Materials of the first metal layer 21112 and the second metal layer 2113 may be the same or different. For example, when the first active material layer 2112a and the second active material layer 2112b have the same polarities, the materials of the first metal layer 21112 and the second metal layer 2113 may be the same. When the first active material layer 2112a and the second active material layer 2112b have opposite polarities, the materials of the first metal layer 21112 and the second metal layer 2113 may be different.

In some embodiments, a material of the packaging member 10 is the same as a material of the first metal layer 21112. For example, if the material of the packaging member 10 is aluminum foil or an aluminum hard shell, the material of the first metal layer 21112 may be aluminum foil.

The material of the packaging member 10 being the same as the material of the first metal layer 21112 avoids excessive electrode potential differences between the packaging member 10 and the second region 2111b, thereby reducing the risk of electrochemical corrosion, which is beneficial to improving the safety performance of the battery cell 100 and extending the service life of the battery cell 100.

In some embodiments, the material of the packaging member 10 may be similar to the material of the first metal layer 21112. The material of the packaging member 10 being similar to the material of the first metal layer 21112 means that the material of the packaging member 10 and the material of the first metal layer 21112 are not exactly the same, but during the cycling process of the battery cell 100, the electrode potential difference between the packaging member 10 and the first metal layer 21112 is small, making electrochemical corrosion unlikely. For example, if the material of the packaging member 10 is stainless steel foil or a stainless steel hard shell, the material of the first metal layer 21112 may be copper foil.

The material of the packaging member being similar to the material of the first metal layer 21112 reduces the electrode potential difference between the packaging member 10 and the second region 2111b, thereby reducing the risk of electrochemical corrosion, which is beneficial to improving the safety performance of the battery cell 100 and extending the service life of the battery cell 100.

As shown in FIG. 12, FIG. 13, and FIG. 15, in some embodiments, the material of the packaging member 10 is different from the material of the first metal layer 21112. The battery cell 100 further includes an insulating layer 30, where, along the first direction X, the insulating layer 30 is provided between a surface of the second region 2111b facing the second electrode plate group 22 and the packaging member 10 to separate the packaging member 10 and the second region 2111b.

Along the first direction X, the insulating layer 30 is provided between the second region 2111b and the seventh wall portion 119 to insulate and separate a portion of the first metal layer 21112 located in the second region 2111b and the seventh wall portion.

For example, if the material of the packaging member 10 is aluminum foil or an aluminum hard shell, the material of the first metal layer 21112 may be copper foil. If the material of the packaging member 10 is stainless steel foil or a stainless steel hard shell, the material of the first metal layer 21112 may be aluminum foil.

The material of the insulating layer 30 includes, but is not limited to, plastic or ceramic.

The material of the packaging member 10 being different from the material of the first metal layer 21112 allows for selection of respective optimal materials for the packaging member 10 and the current collector 2111, resulting in better performance of both the packaging member 10 and the current collector 2111. When the material of the packaging member 10 is different from the material of the first metal layer 21112, the insulating layer 30 being provided between the packaging member 10 and the second region 2111b of the current collector 2111 separates the packaging member 10 and the second region 2111b, reducing the risk of electrochemical corrosion due to excessive electrode potential differences between the packaging member 10 and the second region 2111b, which is beneficial to improving the safety performance of the battery cell 100 and extending the service life of the battery cell 100.

The insulating layer 30 may be provided on a surface of the packaging member 10 facing the second region 2111b in the first direction X, or the insulating layer 30 may be provided on a separator 20b between the first electrode plate 211 and the second electrode plate group 22. In some embodiments, the insulating layer 30 is provided in the second region 2111b. Specifically, the insulating layer 30 is provided on a surface of a portion of the first metal layer 21112 located in the second region 2111b facing away from the insulating separation layer 21111. The insulating layer 30 may be adhered to the second region 2111b.

The insulating layer 30 being provided in the second region 2111b of the current collector 2111 can separate the second region 2111b and the packaging member 10 in the first direction X, reducing the risk of electrochemical corrosion due to excessive electrode potential differences between the packaging member 10 and the second region 2111b, which is beneficial to improving the safety performance of the battery cell 100 and extending the service life of the battery cell 100. Since the side of the second region 2111b facing the second electrode plate group 22 is not provided with the active material layer 2112, the insulating layer 30 being provided in the second region 2111b can also mitigate the problems of warping and curling of the first electrode plate 211 in the second region 2111b.

The thickness of the insulating layer 30 may be less than a thickness of the active material layer 2112 of the current collector 2111 of the first electrode plate 211 facing the second electrode plate group 22, meaning that the thickness of the insulating layer 30 may be less than the thickness of the first active material layer 2112a, to reduce the impact of providing the insulating layer 30 on the space utilization of the battery cell 100. A surface of the insulating layer 30 facing away from the second region 2111b may adhere to an inner surface of the packaging member 10.

In embodiments where the battery cell 100 includes the insulating layer 30, a portion of the first active material layer 2112a in the first direction X is located within the first accommodation cavity 111, meaning that a portion of the first active material layer 2112a extending beyond the insulating layer 30 in the first direction X is located within the first accommodation cavity 111, and another portion of the first active material layer 2112a in the first direction X is located within the first accommodation cavity 111.

As shown in FIG. 1, the battery cell 100 further includes a positive electrode tab 40 and a negative electrode tab 50, where the positive electrode tab 40 is electrically connected to a positive electrode plate and extends out of the packaging member 10, and the negative electrode tab 50 is connected to a negative electrode plate and extends out of the packaging member 10. As shown in FIG. 1, the positive electrode tab 40 and the negative electrode tab 50 may extend out from the same end of the packaging member 10 along the third direction Z. In some other embodiments, the positive electrode tab 40 and the negative electrode tab 50 may extend out from opposite ends of the packaging member 10.

The positive electrode tab 40 and a current collector of the positive electrode plate may be integrally formed. For example, the positive electrode tab 40 and the current collector of the positive electrode plate may be formed by die-cutting a base material, thereby achieving integral formation of the positive electrode tab 40 and the current collector of the positive electrode plate. Alternatively, the positive electrode tab 40 and the current collector of the positive electrode plate may be separately provided and then connected as a whole by welding, conductive adhesive bonding, riveting, or the like.

The negative electrode tab 50 and a current collector of the negative electrode plate may be integrally formed. For example, the negative electrode tab 50 and the current collector of the negative electrode plate may be formed by die-cutting a base material, thereby achieving integral formation of the negative electrode tab 50 and the current collector of the negative electrode plate. Alternatively, the negative electrode tab 50 and the current collector of the negative electrode plate may be separately provided and then connected as a whole by welding, conductive adhesive bonding, riveting, or the like.

An embodiment of the present application further provides an electric device, where the electric device includes the battery cell 100 according to any of the foregoing embodiments.

The battery cell 100 provided in the above embodiments has a high energy density, which is beneficial to improving the reliability of power supply for an electric device powered by the laminated battery cell 100.

The above are merely preferred embodiments of the present application and are not intended to limit the present application. For those skilled in the art, the present application may have various modifications and variations. Any modification, equivalent replacement, or improvement made without departing from the spirit and principle of the present application shall fall within the protection scope of the present application.

What is claimed is:

1. A battery cell, comprising: a packaging member and an electrode assembly, wherein the electrode assembly is accommodated within the packaging member, and the electrode assembly is a laminated structure; and
the electrode assembly comprises:
a first electrode plate group; and
a second electrode plate group, wherein the first electrode plate group and the second electrode plate group are stacked along a first direction; and along a second direction, a length of the first electrode plate group is greater than a length of the second electrode plate group, the second direction being perpendicular to the first direction;
wherein the first electrode plate group comprises a first electrode plate closest to the second electrode plate group, the first electrode plate comprises a current collector and an active material layer, the current collector comprises a first region and a second region; along a thickness direction of the current collector, both sides of the first region are provided with the active material layer, the second region is provided with the active material layer only on a side facing away from the second electrode plate group, the first region at least partially overlaps with the first electrode plate group, and the second region at least partially does not overlap with the first electrode plate group.

2. The battery cell according to claim 1, wherein the packaging member forms an accommodation cavity, the accommodation cavity comprises a first accommodation cavity and a second accommodation cavity, the first accommodation cavity and the second accommodation cavity are arranged along the first direction; and along the second direction, a length of the second accommodation cavity is greater than a length of the first accommodation cavity; and
the active material layer comprises a first active material layer provided on a side of the current collector facing the second electrode plate group and a second active material layer provided on a side of the current collector facing away from the second electrode plate group, wherein at least a portion of the first active material layer and the second electrode plate group are accommodated in the first accommodation cavity, and the current collector and the second active material layer are accommodated in the second accommodation cavity.

3. The battery cell according to claim 1, wherein the current collector is a first metal layer.

4. The battery cell according to claim 1, wherein the current collector comprises an insulating separation layer, a first metal layer, and a second metal layer; the first metal layer being provided on a side of the insulating separation layer facing the second electrode plate group, and the second metal layer being provided on a side of the insulating separation layer facing away from the second electrode plate group.

5. The battery cell according to claim 3, wherein the packaging member comprises a third metal layer, a material of the third metal layer is the same as a material of the first metal layer.

6. The battery cell according to claim 3, wherein the packaging member comprises a third metal layer, a material of the packaging member is different from a material of the first metal layer; and
the battery cell further comprises an insulating layer; wherein along the first direction, the insulating layer is provided between a surface of the second region facing the second electrode plate group and the packaging member to separate the packaging member and the second region.

7. The battery cell according to claim 6, wherein the insulating layer is provided in the second region.

8. The battery cell according to claim 1, wherein a thickness of the current collector is denoted as H, wherein 0.003 mm≤H≤0.030 mm.

9. The battery cell according to claim 8, wherein 0.004 mm≤H≤0.020 mm.

10. The battery cell according to claim 1, wherein the packaging member comprises a main body portion, the main body portion comprises a first main body portion and a second main body portion, the first main body portion and the second main body portion are arranged side by side along the second direction, the second main body portion has a first outer surface in the first direction, and the first main body portion protrudes from the first outer surface;
wherein when viewed along the first direction, the first electrode plate group comprises a first portion overlapping with the second electrode plate group and a second portion not overlapping with the second electrode plate group, the first portion and the second portion being arranged along the second direction and connected; and
the first portion and the second electrode plate group are accommodated in the second main body portion, and the second portion is accommodated in the first main body portion.

11. The battery cell according to claim 1, wherein, a thickness of the first region is smaller than a thickness of the second region.

12. The battery cell according to claim 1, wherein the battery cell comprises a negative electrode plate and a positive electrode plate, the negative electrode plate comprises a negative electrode active material, the negative electrode active material is silicon.

13. The battery cell according to claim 5, wherein the material of the third metal layer is aluminum foil or an aluminum hard shell.

14. The battery cell according to claim 5, wherein the material of the third metal layer is stainless steel foil or a stainless steel hard shell.

15. The battery cell according to claim 1, wherein the battery cell further comprises an insulating layer, the insulating layer is adhered to the second region.

16. The battery cell according to claim 15, a thickness of the insulating layer is less than a thickness of the active material layer of the current collector.

17. The battery cell according to claim 10, wherein the packaging member further comprises a first sealing portion, the first sealing portion is folded around an axis parallel to a third direction to adhere to the side of the second main body portion facing away from the first main body portion; the first direction, the second direction, and the third direction are perpendicular to each other.

18. The battery cell according to claim 10, wherein the packaging member further comprises a second sealing portion, the second sealing portion is folded around an axis parallel to a third direction to adhere to the side of the second main body portion facing away from the first main body portion; the first direction, the second direction, and the third direction are perpendicular to each other.

19. The battery cell according to claim 1, wherein the first electrode plate group includes a first outer electrode plate farthest from the second electrode plate group, wherein the first outer electrode plate is coated with the active material layer on a single surface.

20. An electric device, comprising the battery cell according to claim 1.
